(19) United States
(12) Patent Application Publication
(10) Pub. No.: US 2016/0330931 A1
(43) Pub. Date: Nov. 17, 2016

(54) Daily Dally Animal Pillow

(71) Applicant: Cynthia Ambs, Reston, VA (US)

(72) Inventor: Cynthia Ambs, Reston, VA (US)

(21) Appl. No.: 14/710,741

(22) Filed: May 13, 2015

(51) Int. Cl. A01K 1/035

(52) U.S. Cl. CPC A01K 1/0353

(57) ABSTRACT

A circular, annular, doughnut- shaped pillow for any domesticated animal. It has no shape restricting bottom or top and can be stretched/adapted to any shape the pet chooses when sleeping. It is placed on top of whatever surface the owner chooses and can be slept within, upon and under. It is constructed by taking a length of fabric determined by the required circumference and the width at 12″ and sewing the short ends together to create a circular shape. The sides are then created by sewing the length together with one long seam leaving a small hole for stuffing with fiberfill by a fiberfill packing machine and then being sewn closed when filled along the same long inner seam. The material used is a non-fraying material like fleece so the seam does not need to be bound. This creates a soft doughnut shaped pillow as shown in FIG. 001 and FIG. 002.

### CROSS-REFERENCE TO RELATED APPLICATIONS

non-applicable

### STATEMENT REGARDING FEDERALLY SPONSORED RESEARCH OR DEVELOPMENT

non-applicable

### REFERENCE TO SEQUENCE LISTING, A TABLE, OR A COMPUTER PROGRAM LISTING COMPACT DISC APPENDIX

non-applicable

### BACKGROUND OF THE INVENTION

This design will assist in making pets feel secure and/or comfortable. Pets can curl up in it, on it, or both creating a warm, secure place to “Daily Dally” wherever it is placed. This design also solves the problem of washing structural dog beds that bunch up and fall out of shape and hold hair, dander, dust in the crevices causing the item to smell after a time as in U.S. Pat. No. 3,902,456 Dog Bed.

### BRIEF SUMMARY OF THE ITEM

A circular pillow for pets.

### BRIEF DESCRIPTION OF THE SEVERAL VIEWS OF THE DRAWING

FIG. 001 a drawing of the item with specifications

FIG. 002 a photo of the actual item

### DETAILED DESCRIPTION OF THE INVENTION

This design is for a circular, annular “doughnut shaped” pet pillow. This circular, annular, pet pillow is a circular fiberfill-filled tube, has no connected bottom or top and allows the pet using it the freedom to stretch it into any position they want. With that there is no place for dust, dander, and dirt to accumulate nor are there any structural elements that prohibit it from adapting to the pet. The lack of structural elements (bottoms, tops . . . anything at a 90′ angle) also allows for ease in cleaning and drying without it losing its' shape. This design has no attached bottom padding that would otherwise restrict it from taking whatever shape it is stretched into. This pillow is created in a round, annular, continuous, tubular shape from washable, durable, and fashionably colored materials. Filled with fiberfill it washes well in a conventional washing machine and dries quickly in a conventional dryer or by air drying. By removing structural elements it will not bunch up or fall out of shape in the wash or with constant use. This pet pillow is created by taking fabric measuring 12″ across and creating a circle by sewing the two end seams together. Then a long seam is sewn around the circumference of the fabric matching the sides together. A space in the seam is left for filling the now constructed contiguous tube with fiberfill with a fiberfill packing machine so that it is stiff enough to hold its shape yet pliable to still bend as needed. After being filled with fiberfill the remaining hole is sewn shut connecting the already sewn seam in one seam all the way around. This pet pillow can be constructed of nylon fleece so that it is soft yet durable and will not fray or rip easily. It will come in many colors and fabric designs, It conforms to the position of the pet user on a rug, a mat, a car carpet, etc. Pets can curl up in it, on it, or both creating a warm, secure place to “Daily Dally” wherever it is placed. This product will be made in a small, medium and large size to accommodate different sizes of pets. Three approximate sizes will be Small 14″, Medium 18″, and Large 24″ inside diameters. This item can also be made in custom sizes. The walls are approximately 12″ around in circumference and measure approximately 4″ across in width and 4″ in height making the total diameter (including the “walls”) approximately at Small 24″, Medium 26″, and Large 32″. The material will be durable and machine washable and dryable. There will be one seam that connects the ends together and one continuous seam on the inside creating the doughnut like annular shape. There will be no zippers, buttons, or ornamentation.

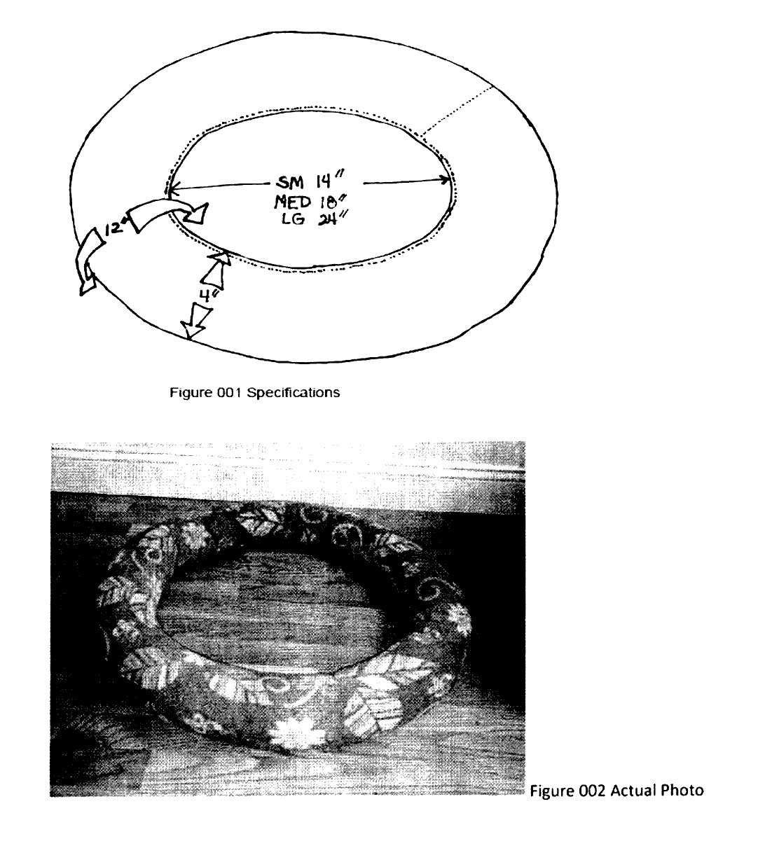

I. I claim the utility design as in FIG. 001 as mine. I have improved on the functionality and design of a structured circular pet bed by creating a singular, circular, annular pillow that will conform to the pet and be highly transportable.

II. This pillow is easily maintained with machine washing and drying.

III. This pillow has no corners or crevices, top or bottom, to retain dirt, dander, and odors.
